(19) United States
(12) Patent Application Publication
(10) Pub. No.: US 2024/0420122 A1
(43) Pub. Date: Dec. 19, 2024

(54) METHOD FOR MAKING A REAL TRUSTLESS CRYPTOCURRENCY UTILIZING ADAPTIVE DIFFERENTIAL PRIVACY BASED WITNESS ENCRYPTION

(71) Applicant: Yoshihiro Sakai, Eastchester, NY (US)

(72) Inventor: Yoshihiro Sakai, Eastchester, NY (US)

(21) Appl. No.: 18/336,275

(22) Filed: Jun. 16, 2023

Related U.S. Application Data
(60) Provisional application No. 63/363,136, filed on Apr. 18, 2022.

(51) Int. Cl. G06Q 20/38; G06Q 20/02

(52) U.S. Cl. CPC G06Q 20/38215; G06Q 20/02

(57) ABSTRACT

A method is disclosed herein that comprises wrapping cryptocurrency utilizing ADP (Adaptive Differential Privacy)-based witness encryption.

### CROSS-REFERENCE TO RELATED APPLICATION

This application claims priority to U.S. Provisional Application No. 63/363,136, filed Apr. 18, 2022, the contents of which are incorporated herein by reference.

### BACKGROUND OF THE DISCLOSURE

The present disclosure relates to network security protocols and, more particularly, to cryptographic mechanism arrangements used for secret or secure communications.

Current state of the art blockchain technology is not able to transfer cryptocurrency between different blockchain systems. As an example, blockchain users are not able to transfer their Bitcoin® to Ethereum®, because the Bitcoin blockchain and the Ethereum blockchain operate independently.

As can be seen, there is a need for improvements in cryptographic mechanism arrangements used for secret or secure communications.

### BRIEF DESCRIPTION OF THE DRAWINGS

The features and advantages of the present invention will become more apparent from the detailed description set forth below when taken in conjunction with the following drawings.

FIG. 1 is a block diagram depicting a blockchain transfer, according to an embodiment; and

FIG. 2 is a block diagram depicting certain processes of the blockchain transfer, according to an embodiment; and

FIG. 3 is a schematic depicting other processes of the blockchain transfer, according to an embodiment; and

FIG. 4 is a block diagram of a general and/or special purpose computer 500.

### DETAILED DESCRIPTION OF THE DISCLOSURE

The following detailed description is of the best currently contemplated modes of carrying out exemplary embodiments of the invention. The description is not to be taken in a limiting sense but is made merely for the purpose of illustrating the general principles of the invention.

As previously stated, prior art blockchain technology is not able to transfer cryptocurrency between different blockchain systems. However, there is a bridging mechanism to make this possible, and the crypto-graphic asset that utilizes this mechanism is wrapped Bitcoin (WBTC). With WBTC, when a user sends Bitcoins to a third party's Bitcoin address, he/she can mint the sending amount as WBTC on the Ethereum blockchain (i.e., increases the bitcoin balance). He/she can also send WBTC to other users on the Ethereum blockchain. When a user who holds WBTC redeems WBTC on the Ethereum blockchain (i.e., decreases the bitcoin balance), a third party can send it back to the user's Bitcoin address.

In the prior art WBTC schemes, a user needs either a custodian that manages the deposited Bitcoins or an individual that provides excessive collateral beyond what they need in standard financial transactions. For example, presently when a user wishes to exchange Bitcoin for WBTC, he/she will be required to send his/her Bitcoin to a merchant. The merchant will initiate a WBTC mint request and send the Bitcoin from the user to a custodian. The custodian will then mint the corresponding WBTC, which will be subsequently transferred to the user via the merchant. When the user wishes to redeem his/her Bitcoin with WBTC, the merchant would communicate with the custodian and transfer the user's Bitcoin back to him/her, while the WBTC token will be burnt.

The custodian is needed because, under the programmatic form of Bitcoin Script used in the Bitcoin protocol, a user could not mint WBTC using cryptography alone. In other words, if the Bitcoin script had the same functionality as a smart contract on the Ethereum blockchain, it would be possible to design a custodian-free WBTC by building a smart contract with logic to verify the state of the Ethereum blockchain and send the deposited Bitcoins according to that state. However, the current Bitcoin script can only support a few cryptographic schemes such as verifying digital signatures.

A general overview of the various features of the invention will be provided, with a detailed description following. Broadly, an embodiment of the present invention provides a method that relies on cryptography using witness encryption (WE) to transfer cryptocurrency on one blockchain to cryptocurrency on another blockchain.

The present invention may utilize wrapped bitcoin (WBTC) configuration using WE. This eliminates a need for custodians or individuals to cooperate in guaranteeing a value through overcollateralization. Specifically, the security of deposited bitcoins is maintained if at least one of the participants in a Multi-Party Computation (MPC) behaves honestly only during address generation. In addition, the anonymity of the deposited address may be improved by randomizing it with a random public key.

WE is a cryptographic scheme already known in the art to realize wrapped bitcoin (WBTC) without a need for an administrator such as a custodian or an individual with incentives (Garg, Gentry, Sahai, & Waters, 2013). While in ordinary public-key cryptography schemes, a holder of a particular secret key can decrypt a ciphertext, in the WE scheme, he/she encrypts a message for an instance to a condition described as a nondeterministic polynomial-time (NP) relation, which is satisfied by inputs and witness in NP problems, and only the holder of that witness can decrypt the ciphertext (Garg et al., 2013) (Goldwasser, Kalai, Popa, Vaikuntanathan, & Zeldovich, 2013).

In an embodiment of the present invention using WBTC, a secret key is encrypted using a WE scheme and only a user who holds a valid witness to amortize a WBTC on the Ethereum blockchain can decrypt the ciphertext when he/she provides the valid witness.

The processes and method steps of the present invention may be utilized to convert cryptocurrency on any blockchain to cryptocurrency on any other blockchain. The present invention may not be limited to Bitcoin and Ethereum or wrapped Bitcoin as the present invention may also be utilized with another wrapped cryptocurrency. The following description of converting from Bitcoin to Ethereum and the utilization of wrapped Bitcoin shall not limit the present invention to such, and references to Bitcoin, the Bitcoin blockchain, Ethereum, or the Ethereum blockchain may be references to cryptocurrencies or cryptocurrency blockchains.

In a deposit process, a user records a public key of a Bitcoin deposit address (Bitcoin address to which a Bitcoin holder sends his or her Bitcoins in order to mint WBTC) in a smart contract of the present invention. The user's Bitcoin is then sent to the Bitcoin deposit address. The user may generate a proof of a deposit with a non-interactive zero-knowledge (NIZK) proof system. If and only if the proof passes a verification, the smart contract will mint the WBTC.

In a withdrawal process, a user may first amortize or burn the WBTC and specifies the public key of the deposit address to be used. If the amortization process completes, the smart contracts may issue an event log or an issue log. Providing the above data along, such as the event log, with a user's digital signature, the user may recover the secret key of the deposit address from the ciphertext. The user may finally send the bitcoin in the deposit address to the user's Bitcoin address.

While the deposit address is generated as an N-of-N multi-signature address, the present invention eliminates a need for a live third party or custodian. Specifically, the security of deposited bitcoins can be maintained as long as at least one of the generators behaves honestly only during address generation. This is because a malicious generator of the multi-signature address needs to collude with all the generators to steal the fund, but a user holding a valid witness can decrypt all of the secret key.

In the process described herein, the present invention may identify transactions for all deposits and withdrawals with other transactions on a cryptocurrency blockchain, since the deposit address is fixed. Using a random public key, the present invention may randomize the deposited address and improve its anonymity. A user in the deposit process additionally generates a random secret key and a random public key and records the random public key in the smart contract. The user then sends the cryptocurrency to a stealth address derived from the random secret key. A user in the withdrawal process recovers the secret key of the stealth address from the decrypted secret key and the random public key, so that the user can withdraw the cryptocurrency in the stealth address. A third party that knows neither the random secret key nor the decrypted secret key cannot derive the stealth address under the decisional Diffie-Hellman (DDH) assumption.

A WE scheme is defined for an NP language (L) (with corresponding witness relation R), and consists of the encryption and decryption algorithms (Garg et al., 2013). To decrypt a ciphertext ct, a valid witness w for the instance x is necessary. Therefore, no one can decrypt the ciphertext encrypted for the x/∈L (i.e. there is no witness w such that R(x, w) holds). This property is defined as “soundness security” in (Garg et al., 2013).

Godlwawsser (Goldwasser et al., 2013) introduced a more robust definition of security: “extractable security.” Informally, this definition guarantees that an adversary must obtain a valid witness w from x, when the adversary can recover the message from the ciphertext for an instance x∈L. The WE scheme used in the present invention may satisfy this since in the present encrypts any secret keys for the instances x∈L.

In the following description of the present invention, it is assumed that the WE scheme is defined for the subset sum language L, which is one of the NP-complete problems. Since a circuit satisfiability problem (circuit-SAT) can be reduced to a subset sum problem, a Boolean circuit C can represent the decryption condition (Bartusek et al., 2020). A message is encrypted for an instance xC depending on the circuit C. The ciphertext is decrypted if the witness w satisfies C(w)=1.

In some embodiments of the present invention, before sending bitcoins to a deposit address, a user records the public key of the Bitcoin deposit address that he/she wishes to use in the smart contract. At substantially a same time, the user also records the user's Externally Owned Account (EOA) address. This process is necessary to prevent two users from sending cryptocurrency to a single cryptocurrency deposit address simultaneously, i.e. Bitcoins to a single Bitcoin deposit address simultaneously. The user needs to use the Bitcoin deposit address for a single deposit and withdrawal, because its secret key has a property that the user can send all Bitcoins associated with their secret key.

The fact that the user sent Bitcoin to a deposit address on the Bitcoin blockchain is proved by non-interactive zero-knowledge (NIZK) proof system on the Ethereum blockchain (e.g., Groth16 (Groth, 2016), Plonk (Gabizon, Williamson, & Ciobotaru, 2019), ZK-STARK (Ben-Sasson, Bentov, Horesh, & Riabzev, 2018)). After sending bitcoins to the deposit address, the user generates a proof of deposit and records it in the smart contract. Only if that proof can pass a verification process described in the smart contract will the WBTC be minted.

The present invention implements functionality of a light client in the Bitcoin network as part of a circuit used by the NIZK proof system. However, the circuit cannot directly perform a verification of a longest chain that requires communication with other nodes (verifying which blockchain is the longest at the moment). Instead, a circuit in the present invention verifies it based on a difficulty value: as a given blockchain, it accepts only those whose cumulative difficulty is greater than a minimum cumulative difficulty value fixed or adjusted in the smart contract.

If the NIZK proof system does not exist, i.e., only a number of succeeding blocks is verified, an attacker could then generate false proofs that pass verification without recording the deposit transaction in the longest chain.
1. Create a branch of the longest chain (referred herein as a “private branch”).
2. Send the attacker's Bitcoins to the deposit address on the private branch.
3. Generate a new block containing the deposit transaction with taking a sufficiently long time.
4. Generate as many blocks as necessary to follow the above blocks. However, the difficulty adjustment algorithm in the Bitcoin protocol allows this process to be completed quickly by lowering the next difficulty, if the attacker intentionally declares a longer time than it took.
5. Feed a block header and deposit transaction in the private branch to the circuit to generate a proof of deposit.
6. Feed that proof to the smart contract. This proof should be able to pass verification so that the present invention may mint the WBTC.

If the attacker includes a delayed timestamp in the block header to reduce the next difficulty, the cumulative difficulty value becomes smaller than the specified minimum value. Therefore, the present invention may mitigate this attack by verifying the cumulative difficulty value.

Cryptocurrency deposits may be realized securely by the following steps:
1. Confirming a format of each block header is correct (e.g., the nonce of each block header satisfies a proof of work (PoW) constraints);
2. Referencing a block hash of each block header as a previous block hash in the block header that follows it, except for the last block header;
3. Confirming a first block header follows a finalized block header where the finalized block header is determined during address generation;
4. Confirming the cumulative difficulty value is greater than the given minimum cumulative difficulty value in the last block header;
5. Confirming the transaction format is correct, and its hash value is contained in a Markle Root in the block header at the specified block height; and
6. Confirming a recipient's address in the transaction is equal to the deposit address, and the transfer amount is equivalent to the value fixed in the system.

To send Bitcoins from a Bitcoin deposit address, the user specifies the public key of the deposit address to be used and amortizes the same amount of WBTC on the Ethereum blockchain. To verify a result of this process, the present invention may use an event log, a record that a smart contract may publish depending on its execution. The smart contract in the present invention may issue an event log containing the specified public key and the user's EOA address only if its amortization process completes. The user then waits for a block containing the event log to be finalized in the Ethereum 2.0 blockchain.

After finalizing that block, the user records a latest block of the Ethereum 2.0 blockchain into the Bitcoin blockchain. A Bitcoin script specification enables an “OP_RETURN script” (Script—Bitcoin Wiki, n.d.) to write arbitrary data into a withdrawal transaction. Using this feature, the user records a block of data as a single Bitcoin transaction, herein referred to as a commitment transaction. Recording the block may prevent block cloaking attacks (also known as a Block Withholding Attack), in which a large group of colluding validators confirms the invalid blocks forked from the current honest chain and hides them. Those dishonest validators can escape the penalty by hiding the block. For this reason, the present invention forces a publication of the same blocks used in a condition on the Bitcoin blockchain.

The user may generate a digital signature using a secret key that corresponds to the user's EOA address. A decryption condition of the WE scheme of the present invention may require a digital signature tied to the EOA address contained in the event log to guarantee that no other user can decrypt the ciphertext. Using the Bitcoin block header and Ethereum 2.0 block header (=Bitcoin/Ethereum 2.0 block header), the latest Ethereum 2.0 block, commitment transaction, event log, and the user's digital signature as witness, the user may withdraw Bitcoin securely by allowing the ciphertext to be decrypted if the user can satisfy the following conditions:
1. The format of each Bitcoin/Ethereum 2.0 block header is correct.
2. A block hash of each Bitcoin/Ethereum 2.0 block header is the previous block hash in a block header that follows it, except for a last one.
3. A first Bitcoin/Ethereum 2.0 block header follows a respective finalized block header. (WE encryption fixes the finalized block header.)
4. A cumulative difficulty value is greater than a minimum cumulative difficulty value in the last Bitcoin block header. (WE encryption fixes the minimum cumulative difficulty value.)
5. A latest Ethereum 2.0 block has been confirmed with a digital signature generated by a good percentage of validators.
6. Data in the block corresponding to the last Ethereum 2.0 block header is recorded in a commitment transaction, which is included in the Bitcoin block at the specified block height.
7. The event log is contained in the Ethereum 2.0 block at a specified block height.
8. The digital signature is generated by the secret key associated with the EOA address in the event log.

After recovering the secret key corresponding to the specified public key through this process, the user generates a digital signature and sends the Bitcoin to the user's Bitcoin address.

A Bitcoin deposit address generator may generate a pair of a new secret key and public key and a Bitcoin deposit address. These empty Bitcoin deposit addresses may be credited with Bitcoins after implementation of a service providing the present invention. The generator may simultaneously encrypt these secret keys with WE and publish the addresses and ciphertext.

The generator may know a user's secret key. In this respect, this process may require trusting the generator. However, this trust model may be replaced to N-of-N multiple signature addresses, which may minimize a risk of a single generator.

According to an embodiment of the present invention, instead of a Bitcoin deposit address generated by a single generator, an N-of-N multi-signature address associated with a public key generated by N different generators may be used as the Bitcoin deposit address. Multi-Party Computation (MPC) among N parties generates a multi-signature address. Specifically, each generator may generate a new secret key and a ciphertext for its WE scheme. Then, N-of-N multi-signature addresses are obtained from all of their corresponding public keys. A digital signature using all of the generated secret keys is required to send cryptocurrency or Bitcoins from that multi-signature address. Therefore, no generator can send cryptocurrency or Bitcoins illegally, except when all the generators collude.

However, this N-of-N multi-signature address itself is a standard method, and simply using it would require the N people in question to gather together and perform some action each time Bitcoin is withdrawn, which is unrealistic in terms of operation. Therefore, while based on N-of-N multiple signature addresses, there should be no need for the generators to gather and perform some action after setup, and there should be no risk of users being unable to withdraw bitcoins. This is achievable with the following method: The generator of each component of the N-of-N multi-signature address may first generate proof that each ciphertext was correctly constructed with the WE scheme using the NIZK proof system. If the proofs of all generators are correct, the N-of-N multiple signature address may be recorded in the smart contract. Then, due to a nature of the WE scheme, only users with legitimate witness will recover all secret keys from the ciphertext and generate digital signatures, which enables them to withdraw the deposited bitcoins at any time.

A following technique, according to some embodiments of the present invention, may implement a mechanism to improve the system's privacy. Transactions for all deposits and withdrawals with other transactions on the Bitcoin blockchain may be identified. However, the deposit address may be made random by adding one random public key, and the randomized address may be made indistinguishable from other addresses for any third party.

In the following description, Fp denotes a finite field of prime order p. Let G be a group of prime order p, and let G∈G be its generator. Fp denotes a finite field of prime order p. Let G be a group of prime order p, and let G∈G be its generator.

The deposit process may be randomized by modifying it as follows. (In the following description.
1. The user generates additional random secret key r∈Fp and public key rG∈G.
2. Before sending bitcoins, the user records rG in the smart contract along with the user's EOA address and the specified public key of the fixed Bitcoin deposit address pkD∈G.
3. The user generates a unique stealth address (a random address that can only be obtained between two parties and cannot be distinguished from any other address by any other third party) from pkD and r. The public key corresponding to the stealth address is computed as pkD+Hash(r·pkD) G∈G. The user then transfers bitcoins to the stealth address.
4. Proof of deposit in the NIZK proof system provides additional proof that the recipient's Bitcoin address is a stealth address correctly calculated from pkD and r. It also guarantees that rG is equivalent to the recorded random public key.

Similarly, the withdrawal process is randomized by modifying it as follows.
1. Obtain rG associated with the specified pkD in the WBTC amortization process.
2. Recover the secret key of the fixed public key (fixed secret key) skD∈Fp from the ciphertext, and then recover the secret key of the stealth address from skD and rG by computing skD+Hash(r·pkD)∈Fp.
3. Generate a digital signature using the secret key of the stealth address and send bitcoin from the stealth address.

Note that skD must be recovered first to recover the secret key of the stealth address because pkD and r generate the public key of the stealth address, while skD and a rG can obtain the secret key according to an embodiment of the present invention. This method guarantees that the user who generates the stealth address in the deposit process will not get the secret key for the stealth address.

In some embodiments of the present invention, an ADP (Adaptive Differential Privacy) based WE scheme as proposed in Bartusek (Bartusek et al., 2020) may be utilized. While there is no security reduction to the standard assumptions for this scheme, it only uses linear algebra, e.g., random matrix sampling, matrix multiplication, and a determinant.

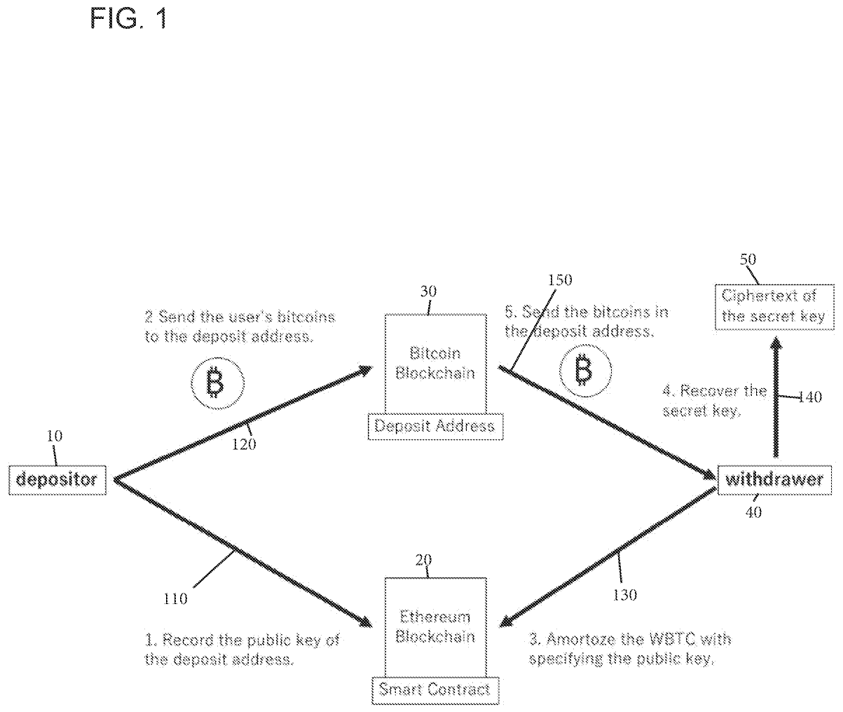

Referring now to the Figures, FIG. 1 is a schematic depicting method steps according to an embodiment of the present invention. A depositor 10 records a public key of a deposit address 100 on a smart contract 20 on Ethereum blockchain. The depositor 10 sends Bitcoins 120 to a deposit address 30 on a Bitcoin blockchain. A withdrawer 40 amortizes wrapped Bitcoin (WBTC) 130 on the smart contract 20. The withdrawer 40 then recovers a secret key 140 from a ciphertext 50 of the secret key. The withdrawer 40 may then withdraw Bitcoin 150 from the deposit address 30.

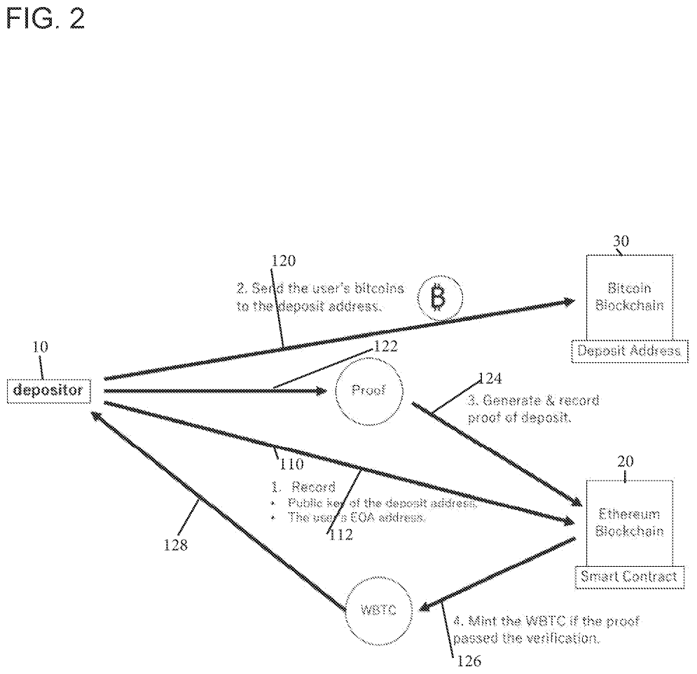

FIG. 2 depicts a deposit process according to an embodiment of the present invention. The depositor 10 records a public key of a deposit address 110 on the smart contract 20 on the Ethereum blockchain and records a user's EOA address 112 on the smart contract 20 at substantially the same time. The depositor 10 then send Bitcoins 120 to the deposit address 30 on the Bitcoin blockchain. A proof of deposit is generated 122. That proof is recorded 124 in the smart contract 20. The smart contract 20 then mints the wrapped Bitcoin (WBTC) 126. The WBTC is sent to the depositor 128.

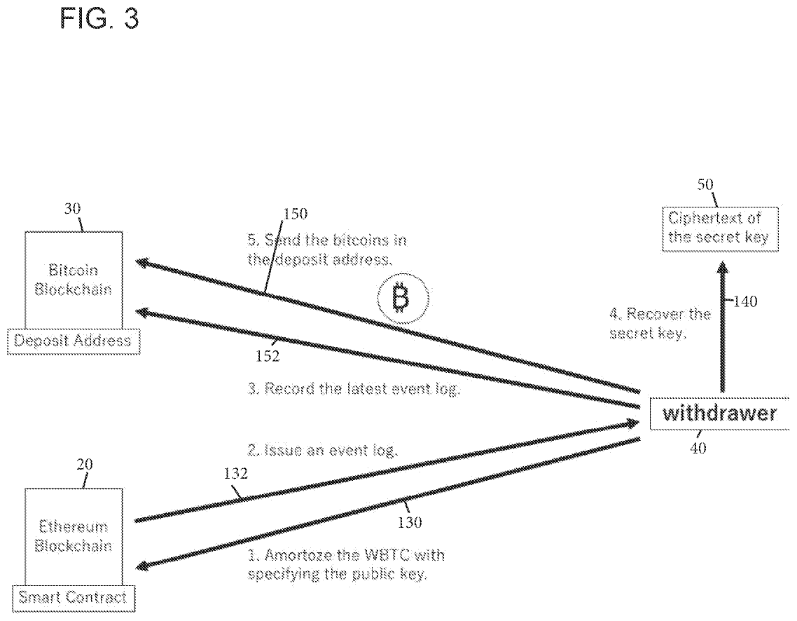

FIG. 3 depicts a withdrawal process according to an embodiment of the present invention. A withdrawer 40 amortizes the WBTC 130 with by specifying a public key. The smart contract 20 issues an event log 132 and sends it to the withdrawer 40. The withdrawer 40 then records the latest event log 152 with the deposit address 30. The withdrawer 40 then recovers the secret key 140 from a ciphertext 50. The withdrawer then may withdraw the Bitcoins 150 in the deposit address 30.

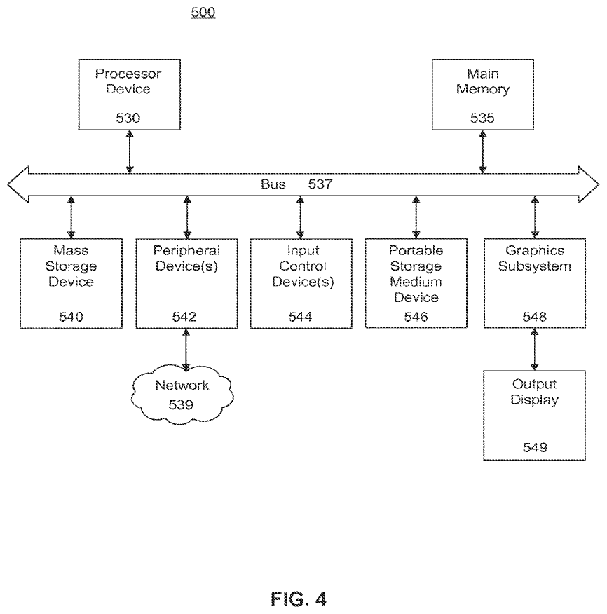

FIG. 4 is a block diagram of a general and/or special purpose computer 500, which may be a general and/or special purpose computing device, in accordance with some of the example embodiments of the invention. The computer 500 may be, for example, a user device, a user computer, a client computer and/or a server computer, among other things.

The computer 500 may include without limitation a processor device 530, a main memory 535, and an interconnect bus 537. The processor device 530 may include without limitation a single microprocessor, or may include a plurality of microprocessors for configuring the computer 500 as a multi-processor system. The main memory 535 stores, among other things, instructions and/or data for execution by the processor device 530. The main memory 535 may include banks of dynamic random-access memory (DRAM), as well as cache memory.

The computer 500 may further include a mass storage device 540, peripheral device(s) 542, non-transitory storage medium device(s) 546, input control device(s) 544, a graphics subsystem 548, and/or a display 549. For explanatory purposes, all components in the computer 500 are shown in FIG. 4 as being coupled through the bus 537. However, the computer 500 is not so limited. Devices of the computer 500 may be coupled through one or more data transport means. For example, the processor device 530 and/or the main memory 535 may be coupled through a local microprocessor bus. The mass storage device 540, peripheral device(s) 542, portable storage medium device(s) 546, and/or graphics subsystem 548 may be coupled via one or more input/output (I/O) buses. The mass storage device 540 may be a nonvolatile storage device for storing data and/or instructions for use by the processor device 530. The mass storage device 540 may be implemented, for example, with a magnetic disk drive or an optical disk drive. In a software embodiment, the mass storage device 540 is configured for loading contents of the mass storage device 540 into the main memory 535.

The portable storage medium device 546 operates in conjunction with a nonvolatile portable storage medium, such as, for example, a compact disc read only memory (CD-ROM), to input and output data and code to and from the computer 500. In some embodiments, the software for storing information may be stored on a portable storage medium, and may be inputted into the computer 500 via the portable storage medium device 546. The peripheral device(s) 542 may include any type of computer support device, such as, for example, an input/output (I/O) interface configured to add additional functionality to the computer 500. For example, the peripheral device(s) 542 may include a network interface card for interfacing the computer 500 with a network 439.

The input control device(s) 544 provide a portion of the user interface for a user of the computer 500. The input control device(s) 544 may include a keypad and/or a cursor control device. The keypad may be configured for inputting alphanumeric characters and/or other key information. The cursor control device may include, for example, a handheld controller or mouse, a trackball, a stylus, and/or cursor direction keys. In order to display textual and graphical information, the computer 500 may include the graphics subsystem 548 and the output display 549. The output display 549 may include a cathode ray tube (CRT) display and/or a liquid crystal display (LCD). The graphics subsystem 548 receives textual and graphical information, and processes the information for output to the output display 549.

Each component of the computer 500 may represent a broad category of a computer component of a general and/or special purpose computer. Components of the computer 500 are not limited to the specific implementations provided here.

Software embodiments of the example embodiments presented herein may be provided as a computer program product, or software, that may include an article of manufacture on a machine-accessible or machine-readable medium having instructions. The instructions on the non-transitory machine-accessible machine-readable or computer-readable medium may be used to program a computer system or other electronic device. The machine- or computer-readable medium may include, but is not limited to, floppy diskettes, optical disks, CD-ROMs, and magneto-optical disks or other types of media/machine-readable medium suitable for storing or transmitting electronic instructions. The techniques described herein are not limited to any particular software configuration. They may find applicability in any computing or processing environment. The terms “computer-readable”, “machine-accessible medium” or “machine-readable medium” used herein shall include any medium that is capable of storing, encoding, or transmitting a sequence of instructions for execution by the machine and that causes the machine to perform any one of the methods described herein. Furthermore, it is common in the art to speak of software, in one form or another (e.g., program, procedure, process, application, module, unit, logic, and so on), as taking an action or causing a result. Such expressions are merely a shorthand way of stating that the execution of the software by a processing system causes the processor to perform an action to produce a result.

Portions of the example embodiments of the invention may be conveniently implemented by using a conventional general-purpose computer, a specialized digital computer and/or a microprocessor programmed according to the teachings of the present disclosure, as is apparent to those skilled in the computer art. Appropriate software coding may readily be prepared by skilled programmers based on the teachings of the present disclosure.

Some embodiments may also be implemented by the preparation of application-specific integrated circuits, field programmable gate arrays, or by interconnecting an appropriate network of conventional component circuits.

Some embodiments include a computer program product. The computer program product may be a storage medium or media having instructions stored thereon or therein which can be used to control, or cause, a computer to perform any of the procedures of the example embodiments of the invention. The storage medium may include without limitation a floppy disk, a mini disk, an optical disc, a Blu-ray Disc, a DVD, a CD or CD-ROM, a micro-drive, a magneto-optical disk, a ROM, a RAM, an EPROM, an EEPROM, a DRAM, a VRAM, a flash memory, a flash card, a magnetic card, an optical card, nanosystems, a molecular memory integrated circuit, a RAID, remote data storage/archive/warehousing, and/or any other type of device suitable for storing instructions and/or data.

Stored on any one of the computer readable medium or media, some implementations include software for controlling both the hardware of the general and/or special computer or microprocessor, and for enabling the computer or microprocessor to interact with a human user or other mechanism utilizing the results of the example embodiments of the invention. Such software may include without limitation device drivers, operating systems, and user applications. Ultimately, such computer readable media further include software for performing example aspects of the invention, as described above.

Included in the programming and/or software of the general and/or special purpose computer or microprocessor are software modules for implementing the procedures described above.

While various example embodiments of the present invention have been described above, it should be understood that they have been presented by way of example, and not limitation. It will be apparent to persons skilled in the relevant art(s) that various changes in form and detail can be made therein. Thus, the present invention should not be limited by any of the above-described example embodiments, but should be defined only in accordance with the following claims and their equivalents.

In addition, it should be understood that the accompanying figures are presented for example purposes only. The architecture of the example embodiments presented herein is sufficiently flexible and configurable, such that it may be utilized and navigated in ways other than that shown in the accompanying figures. Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

What is claimed is:

1. A method comprising:
wrapping cryptocurrency utilizing ADP (Adaptive Differential Privacy)-based witness encryption.
